(19) United States
(12) Patent Application Publication
(10) Pub. No.: US 2025/0379825 A1
(43) Pub. Date: Dec. 11, 2025

(54) Network Traffic Transmission Prioritization

(71) Applicant: Apple Inc., Cupertino, CA (US)

(72) Inventors: Cahya A. Masputra, San Jose, CA (US); Sandeep Nair, San Jose, CA (US); Sushant U. Chavan, San Jose, CA (US); Borna Ghavam, San Francisco, CA (US); Sudharshun Mukundan Iyengar, Union City, CA (US); Yunlei Yang, Fremont, CA (US)

(21) Appl. No.: 19/229,458

(22) Filed: Jun. 5, 2025

Related U.S. Application Data
(60) Provisional application No. 63/657,524, filed on Jun. 7, 2024.

(51) Int. Cl. H04L 47/24

(52) U.S. Cl. CPC H04L 47/24

(57) ABSTRACT

In various embodiments, a client device establishes a tethered connection offered by a communication device. The tethered connection includes a prioritized communication channel and a non-prioritized communication channel. The client device transmits first network traffic from a first application to the communication device via the prioritized communication channel to cause the communication device to prioritize communication of the first network traffic. The client device transmits second network traffic from a second application to the communication device via the non-prioritized communication channel. In some embodiments, transmitting the first network traffic includes transmitting the first network traffic via a peer-to-peer link; transmitting the second network traffic includes transmitting the second network traffic to an access point implemented by the communication device. In some embodiments, the communication device transmits the first network traffic via a prioritized outbound network and the second network traffic via a non-prioritized outbound network.

The present application claims priority to U.S. Prov. Appl. No. 63/657,524, entitled “Network Traffic Transmission Prioritization,” filed Jun. 7, 2024, which is incorporated by reference herein in its entirety.

### BACKGROUND

### Technical Field

This disclosure relates generally to wireless communication, and, more specifically, to devices that support tethering.

### Description of the Related Art

Mobile tethering is a versatile feature found in many modern smartphones and tablets. In devices that support this feature, a given device may enable a wireless or wired connection to allow users to share their cellular data connection with other devices, effectively turning the mobile device into a portable router. For example, users may be able to connect laptops, tablets, or other gadgets to the internet using their mobile device's data plan. This functionality can be especially useful when traditional Wi-Fi® networks are unavailable or unreliable such as when working remotely, traveling, or simply needing to get online.

### BRIEF DESCRIPTION OF THE DRAWINGS

FIG. 1 is a block diagram that illustrates one embodiment of network traffic transmission prioritization.

FIG. 2 is a block diagram that illustrates one embodiment of using differing communication networks to prioritize tethered traffic.

FIG. 3 illustrates characteristics of a prioritized communication channel.

FIG. 4 illustrates one embodiment of using differing communication networks to prioritize tethered traffic.

FIG. 5 illustrates one embodiment of prioritization metadata.

FIG. 6 illustrates one embodiment of a network stack for establishing a prioritized communication channel.

FIG. 7 illustrates one embodiment of a network stack for establishing a non-prioritized communication channel.

FIGS. 8-11 are flow diagrams illustrating example methods to facilitate network traffic transmission prioritization.

FIG. 12 is a block diagram illustrating an example computing device implementing functionality described herein.

FIG. 13 is a diagram illustrating example applications for systems and devices implementing functionality described herein.

### DETAILED DESCRIPTION

One limitation of traditional mobile tethering is its one-size-fits-all approach to handling network traffic. Unlike more advanced network hardware that can prioritize certain types of traffic, mobile tethering treats all network traffic equally, without consideration for the varying needs of different applications. For example, if a user is using a video conferencing application on their laptop to make a call while tethered to a phone, the mobile phone may not prioritize the low-latency requirements of the call over other types of traffic, which may be less time-sensitive such as the laptop's email client checking for any newly received email. This can lead to poor performance (or even dropped calls in this example) when high-priority traffic is competing with lower-priority traffic for network access. In today's applications-centric world, where applications can have significant, differing communication demands, this inability to prioritize traffic to meet particular quality of service (QOS) demands can be a significant drawback of traditional mobile tethering.

The present disclosure describes embodiments in which a communication device offers a tethered connection that can allow a connected client device to prioritize particular network traffic over other network traffic. As will be discussed in some embodiments, the communication device provides a tethered connection that includes a prioritized communication channel and a non-prioritized communication channel. If the client device is executing a first application, such as an online gaming application, with more significant demands, the client device can send the network traffic via the prioritized communication channel to cause the communication device to prioritize the network traffic when sending it onward. The client device, however, can send network traffic from a second application with less significant, such as a file transfer application, via the non-prioritized communication channel. In some embodiments, the communication device prioritizes network traffic received via the prioritized communication channel by merely giving the traffic scheduling priority when communicating via the communication device's cellular interface. In other embodiments discussed below, however, the communication device prioritizes the network traffic by communicating it via a prioritized network slice. In particular, a network provider offering service to the communication device may support network slicing, which allows for multiple logical networks (called slices) to be implemented within the same physical infrastructure, each with its own unique characteristics and QoS requirements. In response to receiving prioritized network traffic via the tethered connection, the communication device can route the network traffic via a particular network slice offering greater performance than another network slice, which may be used for non-prioritized traffic. By providing a tethered connection offering greater customization and control over network traffic, a communication device can enable a greater experience to a tethered client device executing applications with differing communication demands.

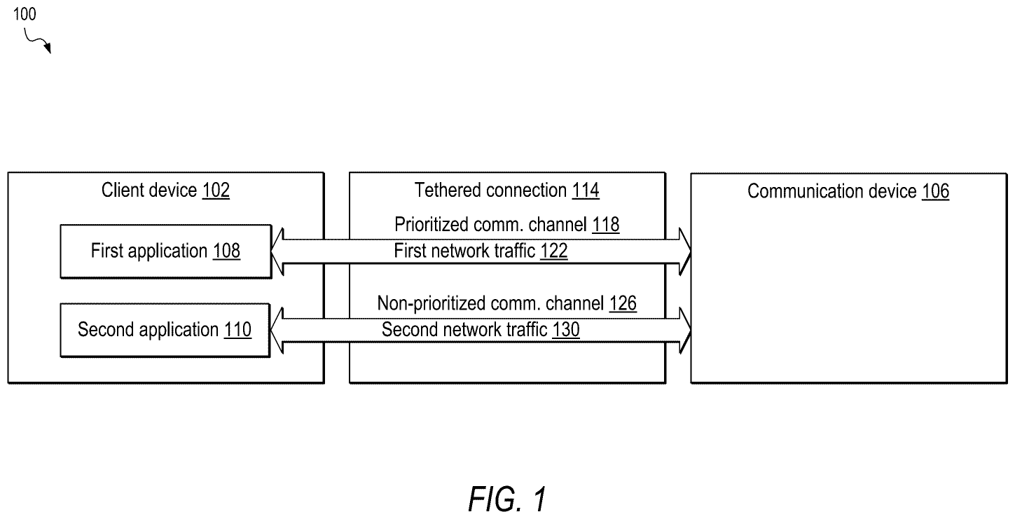

FIG. 1 is a block diagram that illustrates one embodiment of a system 100 that implements network traffic transmission prioritization. System 100 includes client device 102 and communication device 106. A tethered connection 114 is established between communication device 106 and client device 102. Tethered connection 114 corresponds to a wireless communication link established between client device 102 and communication device 106. For example, tethered connection 114 may correspond to a Wi-Fi® connection between client device 102 and communication device 106. However, tethered connection 114 may use a wireless connection other than Wi-Fi® in other embodiments. In some embodiments, client device 102 may initiate a request to establish tethered connection 114 with communication device 106.

Client device 102 may execute a plurality of applications, such as first application 108 and second application 110. For example, the plurality of applications may include software applications. In such an example, first application 108 may correspond to a first software application while second application 110 may correspond to a second software application. First application 108 may, for example, correspond to a latency-sensitive software application, such as a videoconferencing application, a gaming application, or other computationally intensive application in which high latency may hamper performance of the application. In contrast, second application 110 may correspond to a relatively latency-insensitive software application, such as electronic mail or other software applications in which a relatively higher latency may not significantly impact performance of the application.

To accommodate these differing communication demands, tethered connection 114 includes prioritized communication channel 118 and non-prioritized communication channel 126. In some embodiments, prioritized communication channel 118 operates at a lower latency than non-prioritized communication channel 126. For example, prioritized communication channel 118 may have greater bandwidth than non-prioritized communication channel 126 to facilitate a lower latency of operation than non-prioritized communication channel 126. In other embodiments, first network data 122 transmitted over prioritized communication channel 118 is scheduled for transmission prior to second network data transmitted over non-prioritized communication channel 126.

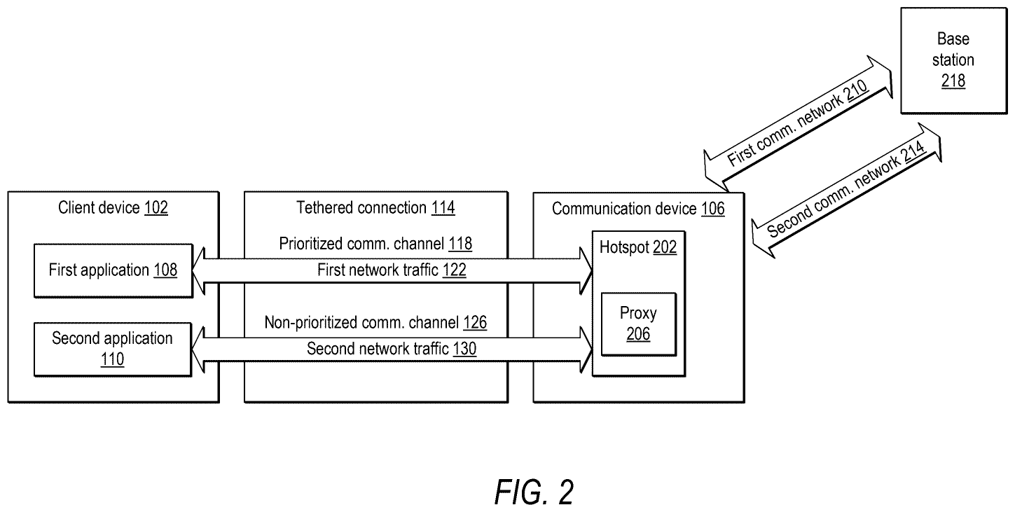

Client device 102 transmits first network traffic 112 associated with first application 108 via prioritized communication channel 118. Further, client device 102 transmits second network traffic 130 via non-prioritized communication channel 126. Receipt of first network traffic 122 at communication device 106 via prioritized communication channel 118 may cause communication device 106 to prioritize communication of first network traffic 122, as explained with reference to FIG. 2. In some embodiments, first application 108 includes an indicator in one or more data packets of first network traffic 122 to indicate that first network traffic 122 is to be transmitted over prioritized communication channel 118. The indicator may be an entitlement indicator included in first network traffic 122 to denote that first network traffic 122 is associated with or was generated by first application 108 that may correspond to an entitled application.

In some embodiments, communication device 106 establishes prioritized communication channel 118 and non-prioritized communication channel 126 using different connection architectures. For example, communication device 106 may establish prioritized communication channel 118 as a peer-to-peer link. The peer-to-peer link may be an ad-hoc link that may use self-assigned Internet protocol (IP) addresses. In contrast, communication device 106 may establish non-prioritized communication channel 126 as a communication link to communication device 106 that operates as a wireless access point (AP), such as in accordance with the IEEE 802.11 communication protocols. To establish the AP and/or AP link with client device 102, communication device 106 may implement dynamic host configuration protocol (DHCP) to assign a local IP address to client device 102, perform network address translation (NAT) for client device 102, implement a firewall, etc. The hosted AP may also be accessible to other devices. In some embodiments, communication device 106 is executable to implement that establishes a network proxy for tethered connection 114 as will be discussed.

FIG. 2 is a block diagram that illustrates one embodiment of using differing communication networks to prioritize tethered traffic. In the illustrated embodiment, communication device 106 is configured to communicate with base station 218 via first communication network 210 and via second communication network 214 in accordance with a network slicing protocol offered by an operator of base station 218.

First communication network 210 and second communication network 214 may, for example, correspond to 5G communication networks. 5G networks typically implement network slicing in which the communication networks have different characteristics. For example, in addition to having lower latency and/or a higher bandwidth than second communication network 214, first communication network 210 may have a higher quality of service (QOS) than second communication network 214.

In response to receipt of first network traffic 122 received via prioritized communication channel 118, communication device 106 is configured to transmit first network traffic 122 via first communication network 210. In some embodiments, inclusion of an indicator, such as an entitlement indicator, in first network traffic 122 causes communication device 106 to transmit first network traffic 122 over first communication network 210 rather than over second communication network 214.

Additionally, communication device 106 is executable to establish hotspot 202 with a network proxy 206 for first network traffic 122 (and potentially second network traffic 130) received from client device 102. In particular, the proxy operates an intermediary system, which can obfuscate the identity of client device 102 such that communication device 106 appears as the source of communication transmitted by client device (e.g., first network traffic 112, second network traffic 130). In some embodiments, to transmit first network traffic 122, client device 102 is configured to transmit first network traffic 122 via proxy 206 using the MASQUE protocol. In this manner, a privacy of a user of client device 102 may be maintained.

Although FIGS. 1 and 2 depict two channels, it may be desirable to have additional channels to accommodate greater variations in application connectivity demands as will be discussed next.

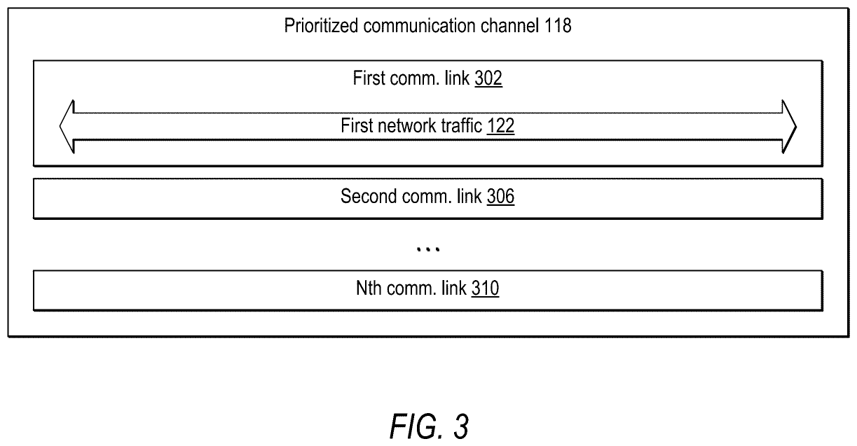

FIG. 3 illustrates characteristics of prioritized communication channel 118 that includes plurality of communication links 302-310. For example, plurality of communication links 302-310 may correspond to different QUIC communication links. In other embodiments, the communication links 302-310 may operate in accordance with other communication protocols. Additionally, in some embodiments, a first set of communication links of plurality of communication links 302-310 may operate in accordance with a first communication protocol, while a second set of communication links of plurality of communication links 302-310 may operate in accordance with a second communication protocol distinct from the first communication protocol. For example, first communication link may operate in accordance with a QUIC communication protocol, while second communication link 306 may operate in accordance with a Layer-3 communication protocol.

While communicating network traffic (e.g., first network traffic 122, second network traffic 130) over separate channels may provide some indicia as to whether particular network traffic should be prioritized or not, communication device 106, however, may still be unable to determine from the network traffic other meaningful information that could allow for greater tailoring of network traffic prioritization, such as knowing which applications (e.g., first application 108 or second application 110) are providing the traffic. As will be discussed, client device 102 may append metadata to network traffic to convey useful information that may not be readily apparent to communication device 106.

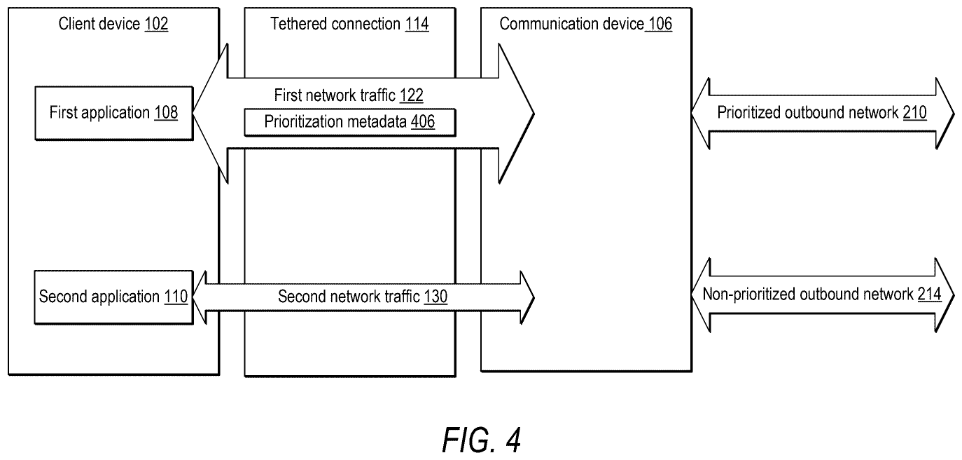

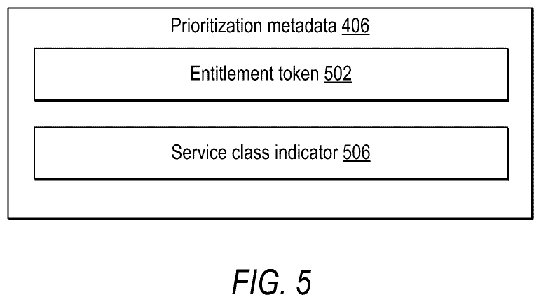

FIG. 4 illustrates one embodiment of including prioritization metadata to convey more meaningful information to communication device 106 about the sources/applications providing network traffic. In the illustrated embodiment, first network traffic 122 includes prioritization metadata 406, the contents of which are discussed in more detail with reference to FIG. 5. In general, prioritization metadata 406 may include information indicating that one or more data packets associated with first network traffic 122 are to be transmitted via prioritized outbound network 210. In some embodiments, first application 108 may encode first network traffic 122 with prioritization metadata 406. In other embodiments, other applications, hardware, or both may encode first network traffic 122 with prioritization metadata 406. Additionally, in some embodiments, client device 102 is configured to encapsulate prioritization metadata 406 in at most one data packet of first network traffic 122. However, in other embodiments, client device 102 is configured to encapsulate prioritization metadata 406 in each data packet of first network traffic 122.

In response to receipt of first network traffic 122 that includes prioritization metadata 406, communication device 106 is configured to transmit first network traffic 122 via prioritized outbound network 210. In contrast to first network traffic 122 that includes prioritization metadata 406, second network traffic 130, lacks prioritization metadata 406. Accordingly, in response to receipt of second network traffic 130, communication device transmits second network traffic 130 via non-prioritized outbound network 214.

FIG. 5 illustrates one embodiment of prioritization metadata 406. Client device 102 is configured to include entitlement token 502 and service class indicator 506 in prioritization metadata 406. Entitlement token 502 indicates that one or more data packets of first network traffic 122 that include prioritization metadata 406 were generated by an entitled application, such as first application 108. Service class indicator 506 indicates a quality of service (QOS) associated with one or more data packets of first network traffic 122. The QoS may correspond to an indicator that the one or more data packets are real-time data packets corresponding to latency-sensitive network traffic, best efforts data packets corresponding to latency-insensitive traffic, or time-triggered data packets corresponding to data packets to be transmitted within a particular timeframe.

Prioritization metadata 406 may also include different, other, or additional indicators. For example, prioritization metadata 406 may include a packet lifetime indicator, application feedback indicators, an acknowledgement (ACK) vs data field, a legacy indicator, a priority indicator indicating a high or a low priority, interface statistics, or combinations thereof. The foregoing may be included in or appended to each data packet of first network traffic 122. As another example, prioritization metadata 406 may include application universally unique identifier (UUID), which may be included in or appended to a first data packet of first network traffic 122 but not to subsequent data packets of first network traffic 122.

In some embodiments, prioritization metadata 406 may be a 32 bit header appended to a data packet of first network traffic 122. A first set of one or more bits may correspond to entitlement token 502, while a second set of one or more bits may correspond to service class indicator 506. Other sets of bits may correspond to other indicators associated with prioritization metadata 406.

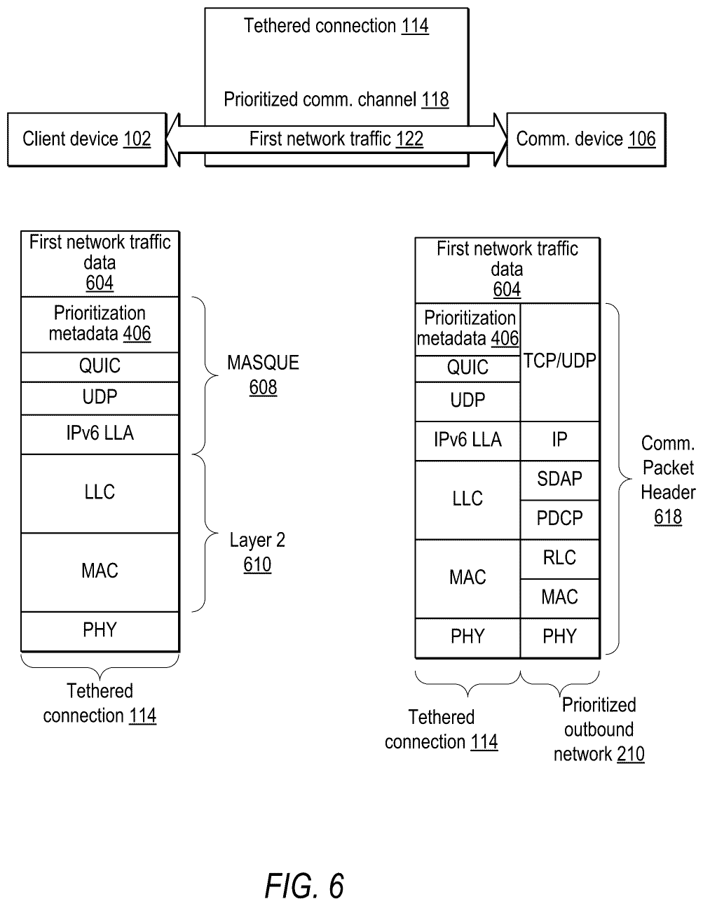

FIG. 6 illustrates one embodiment of a network stack 600 for establishing prioritized communication channel 118. As noted above, prioritized communication channel 118 may be supported by a network proxy implemented by communication device 106. In the illustrated embodiment, this is reflected in traffic 130 including a multiplexed application substrate over QUIC encryption (MASQUE) 608 portion occupying the middle layers of stack 600 including the IPV6, UDP, and QUIC fields in stack 600. Notably, prioritization metadata 406 is included as a field within the MASQUE header of an outbound packet over channel 118, so that this metadata 406 is readily available for analysis when received by communication device 106. As part of implementing a proxy, device 106 may replace MASQUE 608 and the layer 2 610 portions with a communication packet header 618 identifying protocols supported by the prioritized outbound network 210 while preserving the data 604 payload.

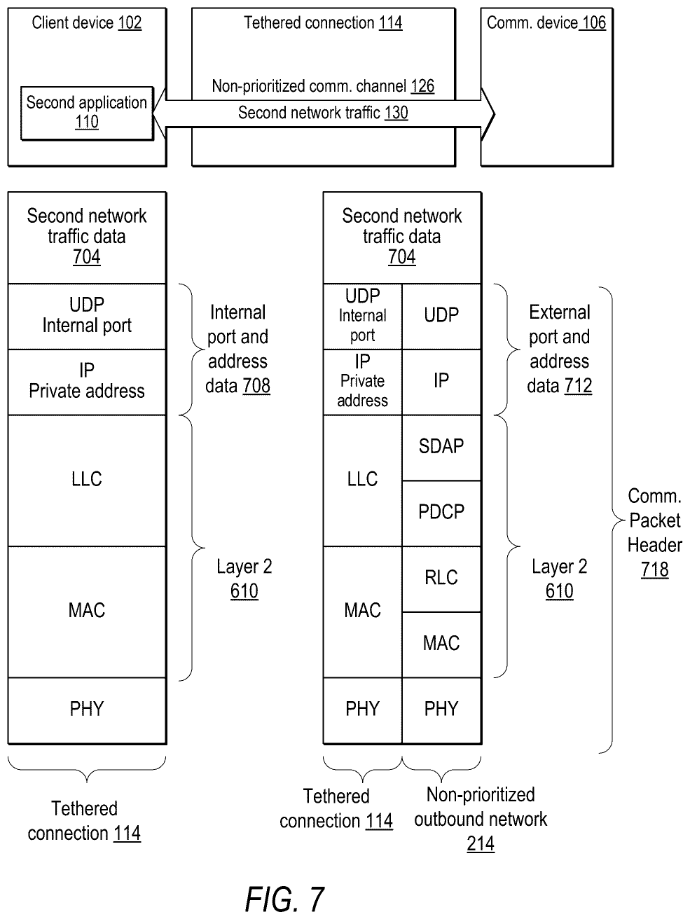

FIG. 7 illustrates one embodiment of network stack 700 for establishing non-prioritized channel 126. In the illustrated embodiment, network traffic 130 is not communicated via a proxy. Thus, traffic 130 lacks the MASQUE 608 portion and, instead, includes standard UDP and IP fields 708 to facilitate transmission of second network traffic data 704 from client device 102 to communication device 106. In some embodiments as shown, the UDP and IP fields 708 may reference internal ports and private IP addresses. When communication device 106 sends second network traffic 130 outbound, communication device 106 may insert a new communication packet header 718 that includes external UDP ports and the external IP address 712 of device 106 after device 106 performs network address translation (NAT).

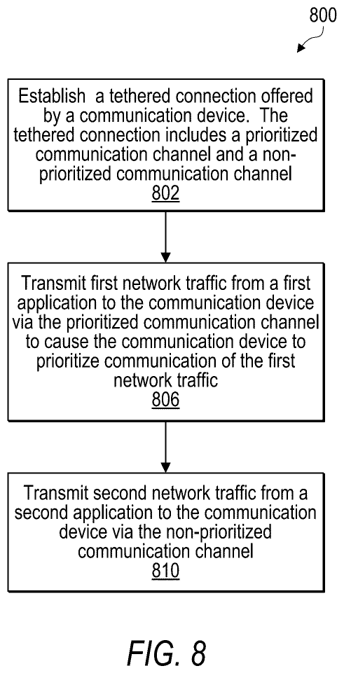

FIG. 8 is a flow diagram illustrating an example method 800 for prioritized transmission of certain network traffic, according to some embodiments. The method shown in FIG. 8 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 802, a client device establishes a tethered connection offered by a communication device. The tethered connection includes a prioritized communication channel and a non-prioritized communication channel. For example, client device 102 may establish tethered connection 114 offered by communication device 106. Tethered connection 114 may include prioritized communication channel 118 and non-prioritized communication channel 126.

At 806, the client device transmits first network traffic from a first application to the communication device via the prioritized communication channel to cause the communication device to prioritize communication of the first network traffic. For example, client device 102 may transmit first network traffic 122 from first application 108 to communication device 106 via prioritized communication channel 118 to cause communication device 106 to prioritize communication of first network traffic 122.

At 810, the client device transmits second network traffic from a second application to the communication device via the non-prioritized communication channel. For example, client device 102 may transmit second network traffic 130 from second application 110 to communication device 106 via non-prioritized communication channel 126.

In some embodiments, to transmit the first network traffic, the client device transmits the first network traffic via a peer-to-peer link. For example, client device 102 may transmit first network traffic 122 via a peer-to-peer link, and, in some embodiments, the peer-to-peer link corresponds to prioritized communication channel 118. Additionally, to transmit the second network traffic, the client device transmits the second network traffic to an access point implemented by the communication device. For example, client device 102 may transmit second network traffic 130 to an access point implemented by communication device 106. In some embodiments, the access point may operate in accordance with communication protocols corresponding to the 802.11 communication standard.

In some embodiments, to transmit the first network traffic, the client device transmits the first network traffic via a proxy implemented by the communication device. For example, client device 102 may transmit first network traffic 122 via a proxy implemented by communication device 106.

In some embodiments, the prioritized communication channel includes a plurality of communication links. For example, prioritized communication channel 118 may include first communication link 302 through nth communication link 310.

In some embodiments, the plurality of communication links correspond to a plurality of QUIC communication links. For example, the plurality of communication links corresponding to first communication link 302 through nth communication link 310 may correspond to a plurality of QUIC communication links.

In some embodiments, to transmit the first network traffic, the client device transmits the first network traffic via a first communication network of the communication device. For example, client device 102 may transmit first network traffic 122 via first communication network 210 of communication device 106. Additionally, in some embodiments, to transit the second network traffic, the client device transmits the second network traffic via a second communication network of the communication device. For example, client device 102 may transmit second network traffic 130 via second communication network 214 of communication device 106. The second communication network has distinct characteristics from the first communication network. For example, second communication network 214 may have distinct characteristics from first communication network 210.

In some embodiments, the first communication network has a first latency that is lower than a second latency of the second communication network. For example, first communication network 210 has a first latency that is lower than a second latency of second communication network 214.

In some embodiments, to transmit the first network traffic, the client device identifies that at least one data packet of the first network traffic includes an entitlement indicator included in the at least one data packet by the first application. For example, client device 102 may identify that at least one data packet of first network traffic 122 includes an entitlement indicator included in the at least one data packet by first application 108.

In some embodiments, the client device routes the first network traffic over the prioritized communication channel in response to the identifying. For example, client device 102 may route first network traffic 122 over prioritized communication channel 118 in response to identifying that at least one data packet of first network traffic 122 includes an entitlement indicator included in the at least one data packet by first application 108.

In some embodiments, the first network traffic includes latency-sensitive traffic relative to a latency-sensitivity of the second network traffic. For example, first network traffic 122 may include latency-sensitive traffic relative to a latency-sensitivity of second network traffic 130.

In some embodiments, the tethered connection is established by a hotspot operating on the communication device. For example, tethered connection 114 may be established by hotspot 202 operating on communication device 106.

In some embodiments, the first application is more sensitive to latency than the second application. For example, first application 108 may be more sensitive to latency than second application 110.

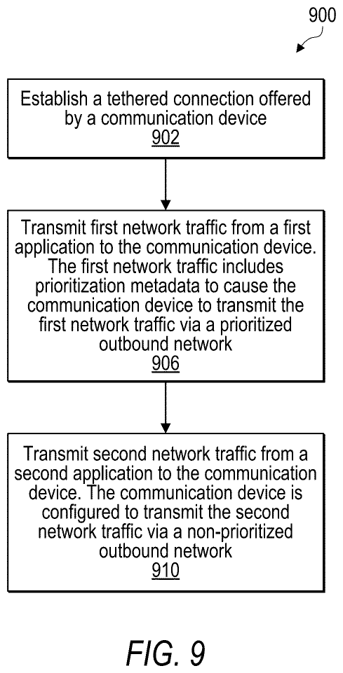

FIG. 9 is a flow diagram illustrating an example method 900 for prioritized transmission of certain network traffic, according to some embodiments. The method shown in FIG. 9 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 902, a client device establishes a tethered connection offered by a communication device. For example, client device 102 may establish tethered connection 114 offered by communication device 106.

At 906, the client device transmits first network traffic from a first application to the communication device. For example, client device 102 may transmit first network traffic 122 from first application 108 to communication device 106. The first network traffic includes prioritization metadata to cause the communication device to transmit the first network traffic via a prioritized outbound network. For example first network traffic 122 may include prioritization metadata 406 to cause communication device 106 to transmit first network traffic 122 via prioritized outbound network 210.

At block 910, the client device transmits second network traffic from a second application to the communication device. For example, client device 102 may transmit second network traffic 130 from second application 110 to communication device 106. The communication device is configured to transmit the second network traffic via a non-prioritized outbound network. For example, communication device 106 may be configured to transmit second network traffic 130 via non-prioritized outbound network 214.

In some embodiments, the client device inserts the prioritization metadata into the first network traffic. For example, client device 102 may insert prioritization metadata 406 into first network traffic 122. The prioritization metadata indicates a service class of the first network traffic. For example, prioritization metadata 406 may indicate a service class of first network traffic 122.

In some embodiments, the prioritization metadata indicates that the first network traffic is entitled to be transmitted over the prioritized outbound network. For example, prioritization metadata 406 may indicate that first network traffic 122 is entitled to be transmitted over prioritized outbound network 210.

In some embodiments, the client device encapsulates the prioritization metadata in each data packet of the first network traffic. For example, client device 102 may encapsulate prioritization metadata 406 in each data packet of first network traffic 122.

In some embodiments, the client device encapsulates the prioritization metadata in at most one data packet of the first network traffic. For example, client device 102 may encapsulate prioritization metadata 406 in at most one data packet of first network traffic 122.

In some embodiments, the tethered connection includes a prioritized communication channel and a non-prioritized communication channel. For example, tethered connection may include prioritization communication channel 118 and non-prioritized communication channel 126.

In some embodiments, the client device transmits the first network traffic from the first application to the communication device via the prioritized communication channel. For example, client device 102 may transmit first network traffic 122 from first application 108 to communication device 106 via prioritized communication channel 118.

In some embodiments, the client device transmits the second network traffic from the second application to the communication device via the non-prioritized communication channel. For example, client device 102 may transmit second network traffic 130 from second application 110 to communication device 106 via non-prioritized communication channel 126.

In some embodiments, the client device includes an entitlement token in the prioritization metadata. For example, client device 102 may include (e.g., insert) entitlement token 502 in prioritization metadata 406.

In some embodiments, the client device determines that the prioritization metadata includes the entitlement token. For example, client device 102 may determine that prioritization metadata 406 includes entitlement token 502.

In some embodiments, to transmit the first network traffic via the prioritized communication channel, the client device transmits the first network traffic in response to a determination, by the client device, that the prioritization metadata includes the entitlement token. For example, to transmit first network traffic 122 via prioritized communication channel 118, client device 102 may transmit first network traffic 122 in response to a determination, by client device 102, that prioritization metadata 406 includes entitlement token 502.

In some embodiments, the client device appending the prioritization metadata to a data payload of a data packet of the first network traffic. For example, client device 102 may append prioritization metadata 406 to a data payload of a data packet of first network traffic 122.

In some embodiments, the prioritized outbound network has a first latency that is lower than a second latency of the non-prioritized outbound network. For example, prioritized outbound network 210 may have a first latency that is lower than a second latency of non-prioritized outbound network 214.

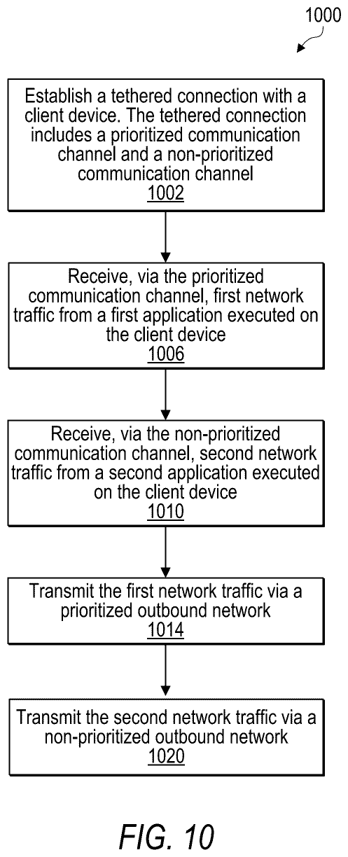

FIG. 10 is a flow diagram illustrating an example method 1000 for prioritized transmission of certain network traffic, according to some embodiments. The method shown in FIG. 10 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1002, a communication device establishes a tethered connection with a client device. For example, communication device 106 establishes tethered connection 114 with client device 102. The tethered connection includes a prioritized communication channel and a non-prioritized communication channel. For example, tethered connection 114 may include prioritized communication channel 118 and non-prioritized communication channel 126.

At 1006, the communication device receives, via the prioritized communication channel, first network traffic from a first application executed on the client device. For example, communication device 106 may receive, via prioritized communication channel 118, first network traffic 122 from first application 108 executed on client device 102.

At 1010, the communication device receives, via the non-prioritized communication channel, second network traffic from a second application executed on the client device. For example, communication device 106 may receive, via non-prioritized communication channel 126, second network traffic 130 from second application 110 executed on client device 102.

At 1014, the communication device transmits the first network traffic via a prioritized outbound network. For example, communication device 106 may transmit first network traffic 122 via first communication network 210.

At 1020, the communication device transmits the second network traffic via a non-prioritized outbound network. For example, communication device 106 may transmit second network traffic 130 via second communication network 214.

In some embodiments, ‘to receive the first network traffic, the communication device receives the first network traffic via a peer-to-peer link. For example, communication device 106 may receive first network traffic 122 via prioritized communication channel 118, which may correspond to a peer-to-peer link.

“In some embodiments, to receive the second network traffic, the communication device receives the second network traffic at an access point. For example, to receive second network traffic 130, communication device 106 may receive second network traffic 130 at an access point hosted by communication device 106. In some embodiments, hotspot 202 may be configured to provide access point features.

In some embodiments, the communication device implements a proxy. For example, communication device 106 may implement proxy 206. The prioritized communication channel is supported by the proxy. For example, prioritized communication channel 118 may be supported by proxy 206.

In some embodiments, the prioritized communication channel includes a plurality of communication links. For example, prioritized communication channel 118 may include first communication link 302 through nth communication link 310.

In some embodiments, the prioritized outbound network has a first latency that is lower than a second latency of the non-prioritized outbound network. For example, first communication network 210 may have a first latency that is lower than a second latency of second communication network 214. As another example, prioritized outbound network 210 may have a lower latency that non-prioritized outbound network 214. In some embodiments first communication network 210 corresponds to prioritized outbound network 210, and second communication network 214 corresponds to non-prioritized outbound network 214.

In some embodiments, the first network traffic includes an entitlement indicator to cause the first network traffic to be routed over the prioritized communication channel. For example, first network traffic 122 may include entitlement token 502 to cause first network traffic 122 to be routed over prioritized communication channel 118.

In some embodiments, first network traffic includes latency-sensitive traffic relative to a latency-sensitivity of the second network traffic. For example, first network traffic 122 may include latency-sensitive traffic relative to a latency-sensitivity of second network traffic 130.

In some embodiments, the communication device establishes a hotspot. For example, communication device 106 may establish hotspot 202. In some embodiments, the tethered connection is established via the hotspot. For example, tethered connection 114 may be established via hotspot 202.

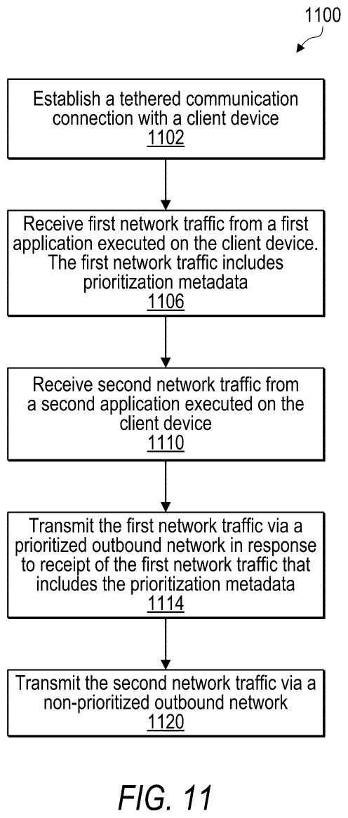

FIG. 11 is a flow diagram illustrating an example method 1100 for prioritized transmission of certain network traffic, according to some embodiments. The method shown in FIG. 11 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1102, a communication device establishes a tethered communication connection with a client device. For example, communication device 106 may establish tethered connection 114 with client device 102.

At 1106, the communication device receives first network traffic from a first application executed on the client device. For example, communication device 106 may receive first network traffic 122 from first application 108 executed on client device 102. The first network traffic includes prioritization metadata. For example, first network traffic 122 includes prioritization metadata 406.

At 1110, the communication device receives second network traffic from a second application executed on the client device. For example, communication device 106 receives second network traffic 130 from second application 110 executed on client device 102.

At 1114, the communication device transmits the first network traffic via a prioritized outbound network in response to receipt of the first network traffic that includes the prioritization metadata. For example, communication device 106 transmits first network traffic 122 via prioritized outbound network 210 in response to receipt of first network traffic 122 that includes prioritization metadata 406. It is understood that prioritized outbound network 210 may correspond to first communication network 210.

At 1120, the communication device transmits the second network traffic via a non-prioritized outbound network. For example, communication device 106 may transmit second network traffic 130 via non-prioritized outbound network 214.

In some embodiments, the prioritization metadata includes a service class of the first network traffic. For example, prioritization metadata 406 may include a service class of first network traffic 122.

In some embodiments, the prioritization metadata indicates that the first network traffic is entitled to be transmitted over the prioritized outbound network. For example, prioritization metadata 406 may indicate that first network traffic 122 is entitled to be transmitted over prioritized outbound network 210.

In some embodiments, the prioritization metadata is encapsulated on a per packet basis. For example, prioritization metadata 406 may be encapsulated on a per packet basis.

In some embodiments, the prioritization metadata is encapsulated on a per connection basis. For example, prioritization metadata 406 may be encapsulated on a per connection basis.

In some embodiments, the prioritization metadata includes entitled tokens from the first application, the entitled tokens indicating that the first application corresponds to an entitled application. For example, prioritization metadata 406 may include entitlement token 502 (e.g., one or more entitlement tokens) from first application 108, entitlement token 502 indicating that first application 108 corresponds to an entitled application.

In some embodiments, the prioritized metadata is appended to a data payload of a data packet corresponding to the first network traffic. For example, prioritized metadata 406 is appended to MASQUE stack 608 of first network traffic data packet 604 corresponding to first network traffic 122.

In some embodiments, the prioritized outbound network has a first latency that is lower than a second latency of the non-prioritized outbound network. For example, prioritized outbound network 210 may have a first latency that is lower than a second latency of non-prioritized outbound network 214.

In some embodiments, the prioritized outbound network has a first latency that is lower than a second latency of the non-prioritized outbound network. For example, prioritized outbound network 210 has a first latency that is lower than a second latency of non-prioritized outbound network 214.

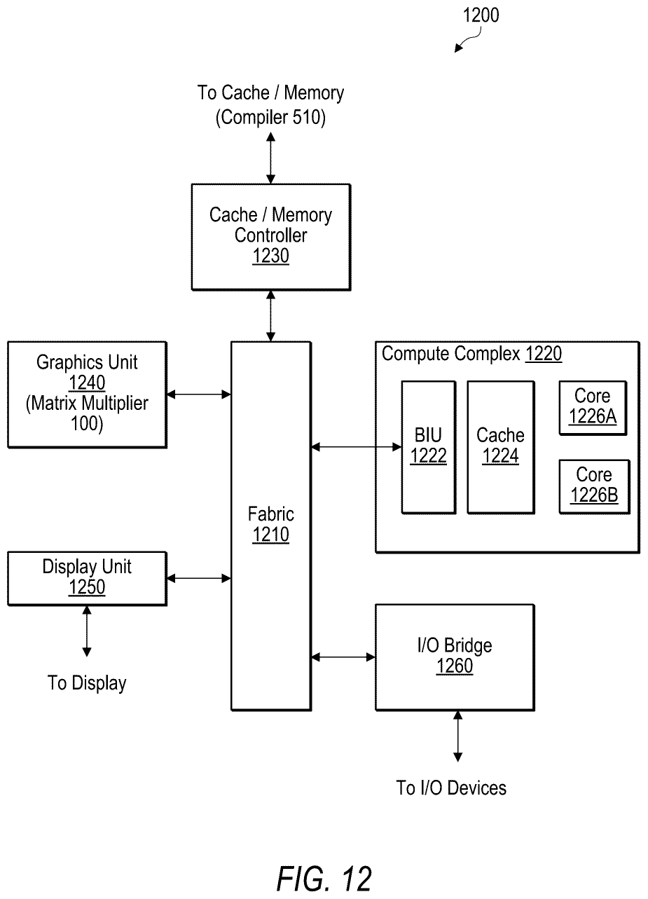

FIG. 12 is a block diagram illustrating an example embodiment of device 1200 is shown. In some embodiments device 1200 may implement functionality of client device 102, communication device 106, or both. In some embodiments, elements of device 1200 may be included within a system on a chip. In some embodiments, device 1200 may be included in a mobile computing device, which may be battery-powered. Therefore, power consumption by device 1200 may be an important design consideration. In the illustrated embodiment, device 1200 includes fabric 1210, compute complex 1220 input/output (I/O) bridge 1260, cache/memory controller 1230, graphics unit 1240, and display unit 1250. In some embodiments, device 1200 may include other components (not shown) in addition to or in place of the illustrated components, such as video processor encoders and decoders, image processing or recognition elements, computer vision elements, etc.

Fabric 1210 may include various interconnects, buses, MUX's, controllers, etc., and may be configured to facilitate communication between various elements of device 1200. In some embodiments, portions of fabric 1210 may be configured to implement various different communication protocols. In other embodiments, fabric 1210 may implement a single communication protocol and elements coupled to fabric 1210 may convert from the single communication protocol to other communication protocols internally.

In the illustrated embodiment, compute complex 1220 includes bus interface unit (BIU) 1222, cache 1224, and cores 1226A-B. In various embodiments, compute complex 1220 may include various numbers of processors, processor cores and caches. For example, compute complex 1220 may include 1, 2, or 4 processor cores, or any other suitable number. In one embodiment, cache 1224 is a set associative L2 cache. In some embodiments, cores 1226A-B may include internal instruction and data caches. In some embodiments, a coherency unit (not shown) in fabric 1210, cache 1224, or elsewhere in device 1200 may be configured to maintain coherency between various caches of device 1200. BIU 1222 may be configured to manage communication between compute complex 1220 and other elements of device 1200. Processor cores such as cores 1226A-B may be configured to execute instructions of a particular instruction set architecture (ISA) which may include operating system instructions and user application instructions. These instructions may be stored in computer readable medium such as a memory coupled to memory controller 1230 discussed below.

As used herein, the term “coupled to” may indicate one or more connections between elements, and a coupling may include intervening elements. For example, in FIG. 12, graphics unit 1240 may be described as “coupled to” a memory through fabric 1210 and cache/memory controller 1230. In contrast, in the illustrated embodiment of FIG. 12, graphics unit 1240 is “directly coupled” to fabric 1210 because there are no intervening elements.

Cache/memory controller 1230 may be configured to manage transfer of data between fabric 1210 and one or more caches and memories. For example, cache/memory controller 1230 may be coupled to an L3 cache, which may in turn be coupled to a system memory. In other embodiments, cache/memory controller 1230 may be directly coupled to a memory. In some embodiments, cache/memory controller 1230 may include one or more internal caches. Memory coupled to controller 1230 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1230 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions, such as applications 108 and 110, hotspot 202, etc., executable by compute complex 1220 to cause device 1200 to perform functionality described herein.

Graphics unit 1240 may include one or more processors, e.g., one or more graphics processing units (GPUs). Graphics unit 1240 may receive graphics-oriented instructions, such as OPENGL®, Metal®, or DIRECT3D® instructions, for example. Graphics unit 1240 may execute specialized GPU instructions or perform other operations based on the received graphics-oriented instructions. Graphics unit 1240 may generally be configured to process large blocks of data in parallel and may build images in a frame buffer for output to a display, which may be included in the device or may be a separate device. Graphics unit 1240 may include transform, lighting, triangle, and rendering engines in one or more graphics processing pipelines. Graphics unit 1240 may output pixel information for display images. Graphics unit 1240, in various embodiments, may include programmable shader circuitry which may include highly parallel execution cores configured to execute graphics programs, which may include pixel tasks, vertex tasks, and compute tasks (which may or may not be graphics-related).

Display unit 1250 may be configured to read data from a frame buffer and provide a stream of pixel values for display. Display unit 1250 may be configured as a display pipeline in some embodiments. Additionally, display unit 1250 may be configured to blend multiple frames to produce an output frame. Further, display unit 1250 may include one or more interfaces (e.g., MIPI® or embedded display port (eDP)) for coupling to a user display (e.g., a touchscreen or an external display).

I/O bridge 1260 may include various elements configured to implement: universal serial bus (USB) communications, security, audio, and low-power always-on functionality, for example. I/O bridge 1260 may also include interfaces such as pulse-width modulation (PWM), general-purpose input/output (GPIO), serial peripheral interface (SPI), and inter-integrated circuit (I2C), for example. Various types of peripherals and devices may be coupled to device 1200 via I/O bridge 1260.

In some embodiments, device 1200 includes network interface circuitry (not explicitly shown), which may be connected to fabric 1210 or I/O bridge 1260. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1200 with connectivity to various types of other devices and networks.

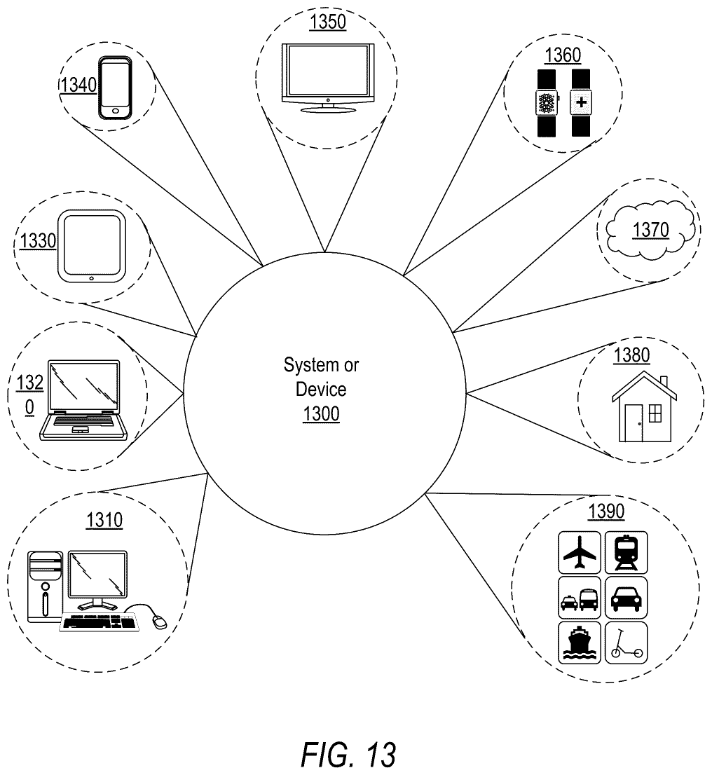

Referring to FIG. 13, various types of systems that may include any of the circuits, devices, or system discussed above is described. System or device 1300, which may incorporate or otherwise utilize one or more of the techniques described herein, may be utilized in a wide range of areas. For example, system or device 1300 may be utilized as part of the hardware of systems such as a desktop computer 1310, laptop computer 1320, tablet computer 1330, cellular or mobile phone 1340, or television 1350 (or set-top box coupled to a television). Additionally, while not illustrated, client device 102 may correspond to a headset (e.g., a virtual reality headset).

Similarly, disclosed elements may be utilized in a wearable device 1360, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1300 may also be used in various other contexts. For example, system or device 1300 may be utilized in the context of a server computer system, such as a dedicated server or on shared hardware that implements a cloud-based service 1370. Still further, system or device 1300 may be implemented in a wide range of specialized everyday devices, including devices 1380 commonly found in the home such as refrigerators, thermostats, security cameras, etc. The interconnection of such devices is often referred to as the “Internet of Things” (IoT). Elements may also be implemented in various modes of transportation. For example, system or device 1300 could be employed in the control systems, guidance systems, entertainment systems, etc. of various types of vehicles 1390.

The applications illustrated in FIG. 13 are merely exemplary and are not intended to limit the potential future applications of disclosed systems or devices. Other example applications include, without limitation: portable gaming devices, music players, data storage devices, unmanned aerial vehicles, etc.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

What is claimed is:

1. A non-transitory computer readable medium having program instructions stored therein that are executable by a client device to perform operations, comprising:
establishing a tethered connection offered by a communication device, wherein the tethered connection includes a prioritized communication channel and a non-prioritized communication channel;
transmitting first network traffic from a first application to the communication device via the prioritized communication channel to cause the communication device to prioritize communication of the first network traffic; and
transmitting second network traffic from a second application to the communication device via the non-prioritized communication channel.

2. The computer readable medium of claim 1, wherein transmitting the first network traffic includes transmitting the first network traffic via a peer-to-peer link, and wherein transmitting the second network traffic includes transmitting the second network traffic to an access point implemented by the communication device.

3. The computer readable medium of claim 1, wherein transmitting the first network traffic includes transmitting the first network traffic via a proxy implemented by the communication device.

4. The computer readable medium of claim 1, wherein the prioritized communication channel includes a plurality of communication links.

5. The computer readable medium of claim 4, wherein the plurality of communication links correspond to a plurality of QUIC communication links.

6. The computer readable medium of claim 1, wherein transmitting the first network traffic includes transmitting the first network traffic via a first communication network of the communication device; and
wherein transmitting the second network traffic includes transmitting the second network traffic via a second communication network of the communication device, the second communication network having distinct characteristics from the first communication network.

7. The computer readable medium of claim 6, wherein the first communication network has a first latency that is lower than a second latency of the second communication network.

8. The computer readable medium of claim 1, wherein transmitting the first network traffic includes:
identifying that at least one data packet of the first network traffic includes an entitlement indicator included in the at least one data packet by the first application; and
routing the first network traffic over the prioritized communication channel in response to the identifying.

9. The computer readable medium of claim 1, wherein the first network traffic includes latency-sensitive traffic relative to a latency-sensitivity of the second network traffic.

10. The computer readable medium of claim 1, wherein the tethered connection is established by a hotspot operating on the communication device; and
wherein the first application is more sensitive to latency than the second application.

11. A method performed by a client device, the method comprising:
establishing a tethered connection offered by a communication device;
transmitting first network traffic from a first application to the communication device, wherein the first network traffic includes prioritization metadata to cause the communication device to transmit the first network traffic via a prioritized outbound network; and
transmitting second network traffic from a second application to the communication device, wherein the communication device is configured to transmit the second network traffic via a non-prioritized outbound network.

12. The method of claim 11, further comprising:
inserting the prioritization metadata into the first network traffic, wherein the prioritization metadata indicates a service class of the first network traffic.

13. The method of claim 11, wherein the prioritization metadata indicates that the first network traffic is entitled to be transmitted over the prioritized outbound network.

14. The method of claim 11, further comprising:
encapsulating the prioritization metadata in each data packet of the first network traffic.

15. A client device, comprising:
one or more processors; and
memory have program instructions stored therein that are executable by the one or more processors to cause the client device perform operations including:
establishing a tethered connection with a communication device;
transmitting first network traffic to the communication device, wherein the first network traffic includes prioritization metadata to cause the communication device to transmit the first network traffic via a prioritized outbound network; and
transmitting second network traffic from a second application to the communication device, wherein the communication device is configured to transmit the second network traffic via a non-prioritized outbound network.

16. The client device of claim 15, wherein the operations further include:
encapsulating the prioritization metadata in at most one data packet of the first network traffic.

17. The client device of claim 15, wherein the tethered connection includes a prioritized communication channel and a non-prioritized communication channel, wherein the operations further include:
transmitting the first network traffic from a first application to the communication device via the prioritized communication channel; and
transmitting the second network traffic from a second application to the communication device via the non-prioritized communication channel.

18. The client device of claim 17, wherein the operations further include:
including an entitlement token in the prioritization metadata; and
determining that the prioritization metadata includes the entitlement token, wherein transmitting the first network traffic via the prioritized communication channel includes transmitting the first network traffic in response to determining that the prioritization metadata includes the entitlement token.

19. The client device of claim 15, wherein the operations further include:
appending the prioritization metadata to a data payload of a data packet of the first network traffic.

20. The client device of claim 15, wherein the prioritized outbound network has a first latency that is lower than a second latency of the non-prioritized outbound network.
